(19) United States
(12) Patent Application Publication
(10) Pub. No.: US 2011/0047328 A1
(43) Pub. Date: Feb. 24, 2011

(54) SIZE PLANNING METHOD FOR STORAGE DEVICE, AND READ AND ACCESS CORRECTING METHODS THEREOF

(75) Inventors: Kuo Wei Huang, Taipei City (TW); Chih Wei Wang, Taipei City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: INVENTEC CORPORATION, Taipei City (TW)

(21) Appl. No.: 12/545,677

(22) Filed: Aug. 21, 2009

(51) Int. Cl. G06F 12/00; G06F 12/02

(52) U.S. Cl. 711/112; 711/170; 711/E12.001; 711/E12.002

(57) ABSTRACT

A size planning method for a storage device, and read and access correcting methods thereof are described. When a computer device is booted, a size of a physical storage device is managed. The management method includes the following steps. A physical storage device connected to a computer device is searched. When a size of the physical storage device is larger than a maximum disk size, a current disk having a specified size is partitioned from the physical storage device. Various parameters of a logical fixed disk parameter table (FDPT) extension table of the current disk are set. A residual size of the physical storage device is partitioned into several disks having the specified size, and the corresponding logical FDPT extension tables are set until the residual size is smaller than the maximum disk size.

### BACKGROUND OF THE INVENTION

1. Field of the Invention

The present invention relates to a size management method for a computer storage device, and more particularly to a size planning method for a storage device and an access method thereof.

2. Related Art

In order to manage the storage space of the storage device, storage device manufacturers define a Master Boot Record (MBR) specification. The MBR is usually set in the first sector of the storage device, thereby providing the related data for the computer device to identify the storage device.

When the computer device is booted, firstly the basic input/output system (BIOS) performs the power on self test (POST). The BIOS determines whether various connected peripherals are normal or not through the POST. Next, the BIOS begins to determine the data of the MBR of the storage device. The MBR on side 0, track 0, and sector 1 of the storage device has a sector space of 512 Bytes. The information stored in the MBR may be divided into three parts, which are respectively a boot partition loader (BPL) (or Pre-Loader or Pre-Boot), partition data, and verify data.

The BPL is stored within a sector scope from 000h to 1BDh and having 446 Bytes. The BPL is mainly used to load the boot sector of the operating system partition area. Then, the control right of the computer device is delivered to the boot sector, so as to continue to load the booting process of the operating system.

The partition data is stored within a sector scope from 1BEh to 1FDh and having 64 Bytes. The scope of 64 Bytes may be divided into four areas, so as to store the data of four hard disk partitions. This is the reason why only four primary partitions, or three primary partitions and one extended partition can be planned at most, when the hard disk partitions are planned by using Fdisk or other programs.

The verify data is stored within a scope from 1FEh to 1FFh and having 2 Bytes. The verify data is marked by a string numerical value of “55AA”, and is used to verify whether the data of the whole sector scope from 000h to 1FFh is the MBR sector or not.

Under the MBR specification, the computer device can only access the storage device having a size smaller 2 Terabytes (which may be calculated as follows: 446+64+2=512 Bytes, 232*512=2 Terabytes). FIG. 1 is a schematic view of a disk parameter setting process in the prior art, and please referring to FIG. 1.

In Step S110, it is detected whether a communication bus is a last communication bus or not.

In Step S120, if the communication bus is not the last communication bus, it is detected whether the communication bus is connected to a physical storage device or not.

In Step S131, an FDPT extension table is set.

In Step S132, disk numbers of the physical storage device are set.

In Step S133, disk driver count values of the BIOS data area in the computer device are modified.

In Step S134, an Identify Driver Command is executed, so as to determine the size of the physical storage device, and Step S110 is repeated until all the communication buses and the connected physical storage devices are completed.

If the physical storage device larger than 2 Terabytes is connected to the computer device, the computer device cannot perform the boot sector configuration on the space of the physical storage device exceeding the upper limit of the size, so as to affect the access to the physical storage device. In the past, in order to enable the computer device to access the physical storage device exceeding the upper limit, the BIOS needs to be replaced. However, for the manufacturers, the replacement of the BIOS is an additional cost. Further, in addition to changing the BIOS, the operating system support is also needed. For a 32-bit operating system, the problem that the physical storage device exceeding 2 Terabytes cannot be normally accessed may still occur.

### SUMMARY OF THE INVENTION

In view of the above problems, the present invention is a size planning method for a storage device. When a computer device is booted, firstly, a physical storage device connected to the computer device is searched. If it is detected that an unpartitioned size of the physical storage device is larger than a maximum disk size, at least one disk is planned in sequence in the unpartitioned size of the physical storage device, until a residual size is smaller than the maximum disk size.

To achieve the above objective, the present invention provides a size planning method for a storage device, which comprises the following steps.

In Step a, it is determined whether an unpartitioned size of a physical storage device is larger than a maximum disk size or not.

In Step b, when the unpartitioned size of the physical storage device is larger than the maximum disk size, a current disk is partitioned from the physical storage device by using a start address indicated by a pointer as a reference.

In Step c, a disk size set value of the current disk is obtained.

In Step d, a content of a fixed disk parameter table (FDPT) extension table of the physical storage device is copied to a logical FDPT extension table of the current disk.

In Step e, disk numbers in the FDPT extension table are modified, and disk numbers in the logical FDPT extension table are overwritten according to the modified disk numbers in the FDPT extension table.

In Step f, a disk driver count value of a basic input/output system (BIOS) data area in the computer device is modified.

In Step g, an Identify Disk Command is executed, so as to plan the current disk having a size of the disk size set value in the physical storage device.

In Step h, when a residual size of the physical storage device is larger than the maximum disk size, the pointer is moved after an end address of the current disk, and Step a to Step h are repeated.

After the physical storage device in a selected communication bus is completed, in the present invention, it is detected whether the remaining communication buses are connected to a physical storage device or not one by one and whether the physical storage device exceeds the maximum disk size or not, and other related processing is performed until all the physical storage devices are completed.

The present invention provides a size planning method for a storage device, capable of establishing several disks in the storage device exceeding the maximum disk size, thereby preventing a problem that a computer device cannot use the unpartitioned size exceeding the maximum disk size.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a disk parameter setting process in the prior art;

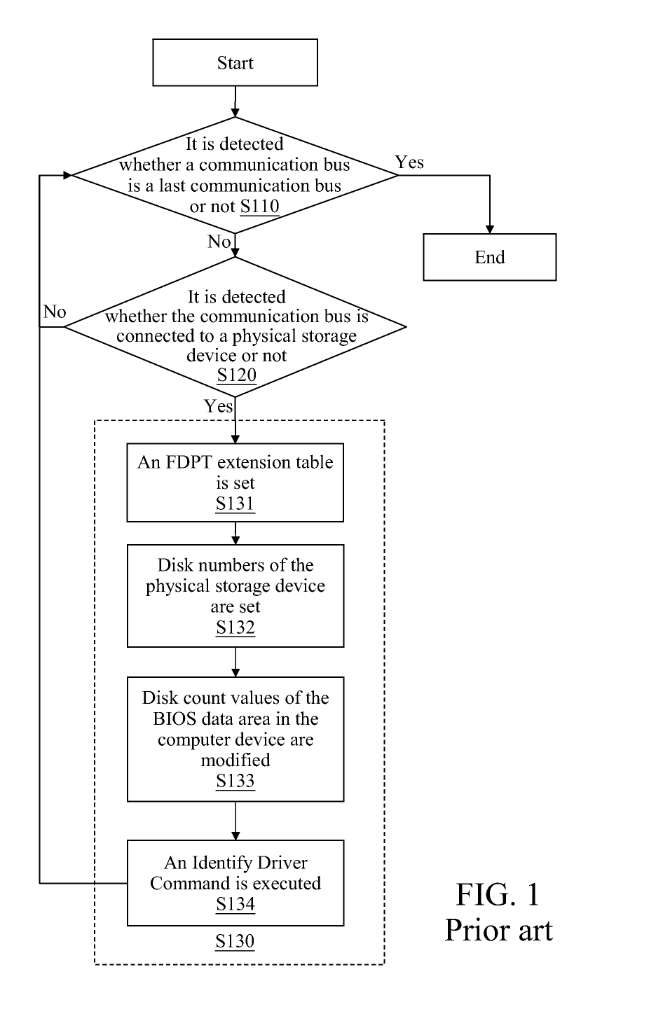

FIG. 2 is a schematic view of the system architecture of the present invention;

FIG. 3 is a schematic view of an operation process of the present invention in a single physical storage device;

FIG. 4 is a schematic view of disks and an unpartitioned size of the physical storage device according to the present invention;

FIG. 5 is a schematic view of a detailed process of a size planning procedure according to the present invention;

FIG. 6A is a schematic flow chart of a size query correcting procedure according to the present invention;

FIG. 6B is a schematic view of the physical storage device having the disks according to the present invention;

FIG. 6C is a schematic view of an error disk size according to the present invention;

FIG. 6D is a schematic view of a corrected disk size according to the present invention;

FIG. 7A is a schematic view according to the present invention, in which a start address of the disk is not corrected;

FIG. 7B is a schematic flow chart of a procedure of correcting the start address of the disk according to the present invention;

FIG. 7C is a schematic view according to the present invention, in which the start address of the disk is corrected;

FIG. 8A is a schematic view of an operation process of the present invention in a plurality of physical storage devices;

FIG. 8B is a schematic view of a detailed process of the size planning procedure according to the present invention;

FIG. 9A is a schematic view of each physical storage device according to the present invention;

FIG. 9B is a schematic view of a first disk according to the present invention;

FIG. 9C is a schematic view of a second disk according to the present invention; and

FIG. 9D is a schematic view of a third disk according to the present invention.

### DETAILED DESCRIPTION OF THE INVENTION

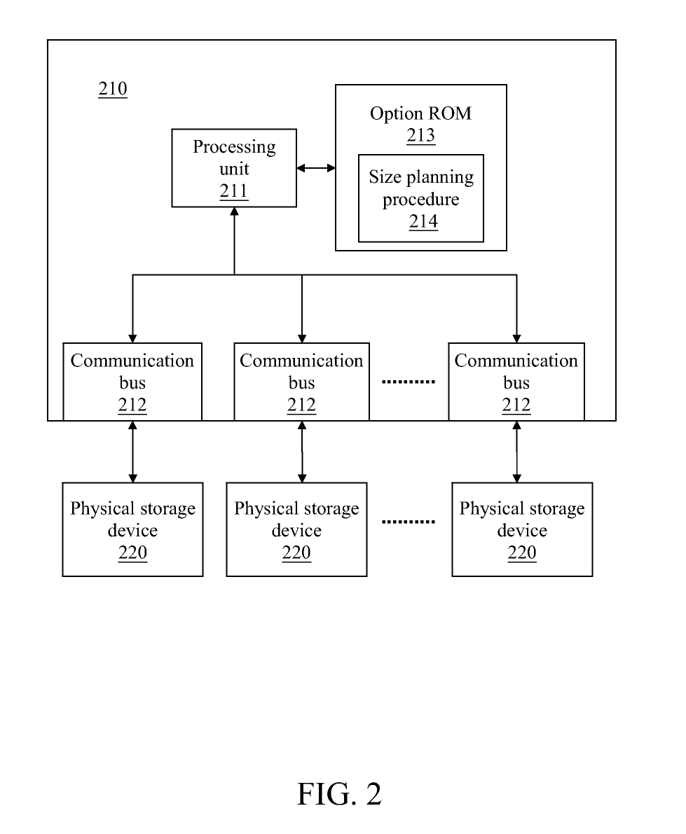

FIG. 2 is a schematic view of the system architecture according to the present invention. Referring to FIG. 2, the architecture according to the present invention comprises a computer device 210 capable of operating a size planning procedure and at least one physical storage device 220. The computer device 210 has a processing unit 211, at least one communication bus 212, and an option read only memory (ROM) 213. The communication bus 212 is connected to the physical storage device 220, and types of the communication bus 212 comprise Integrated Device Electronics (IDE), Serial Advanced Technology Attachment (SATA), Small Computer System Interface (SCSI), external SATA (eSATA), Universal Serial Bus (USB), or Institute of Electrical and Electronics Engineers (IEEE) 1394. In addition to a single hard disk, the physical storage device 220 may be a disk device composed of a Redundant Array of Independent Disks (RAID). The option ROM 213 stores a size planning procedure 214. The option ROM 213 is disposed in an external interface card, for example, the external interface card may be an RAID interface card or a SATA expansion card. In addition, the option ROM 213 may also be built in a main board, such that in a POST process when the computer device 210 is booted, the processing unit 211 may access the size planning procedure 214 from the option ROM 213 in advance, thereby performing a disk planning operation on the physical storage device 220.

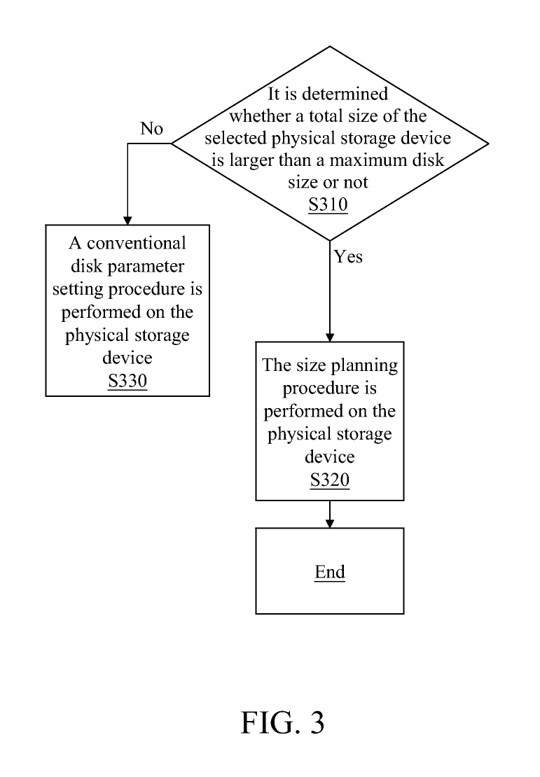

Accordingly, the present invention may be applied to a single physical storage device 220, and may also be implemented in a plurality of physical storage devices 220. In the following, the operation process of the size planning procedure 214 is described by taking a single bus and an independent physical storage device 220 for example, and persons of ordinary skill in the art can apply the procedure to a plurality of physical storage device 220. FIG. 3 is a schematic view of an operation process of the present invention in a single physical storage device. Referring to FIG. 3, the process comprises the following steps.

In Step S310, it is determined whether a total size of the selected physical storage device is larger than a maximum disk size or not.

In Step S320, when the total size of the selected physical storage device is larger than the maximum disk size, the size planning procedure is performed on the physical storage device.

In Step S330, when the total size of the selected physical storage device is smaller than the maximum disk size, a conventional disk parameter setting procedure is performed on the physical storage device (referring to the conventional disk parameter setting procedure: Step S131 to Step S134).

Firstly, the processing unit 211 determines whether an unpartitioned size of the physical storage device 220 is larger than the maximum disk size or not (corresponding Step S310). In the present invention, a value of the maximum disk size is 2 Terabytes. The physical storage device 220 is partitioned into at least one disk, and a residual unpartitioned space is defined as the unpartitioned size. In other words, in the present invention, the unpartitioned size (A) of the physical storage device 220 refers to a difference (Δ=Total_Size−Disk_Size*n, in which n is a disk driver count) obtained by subtracting a total size of all the disks (Disk_Size) from the total size of the physical storage device 220 (Total_Size).

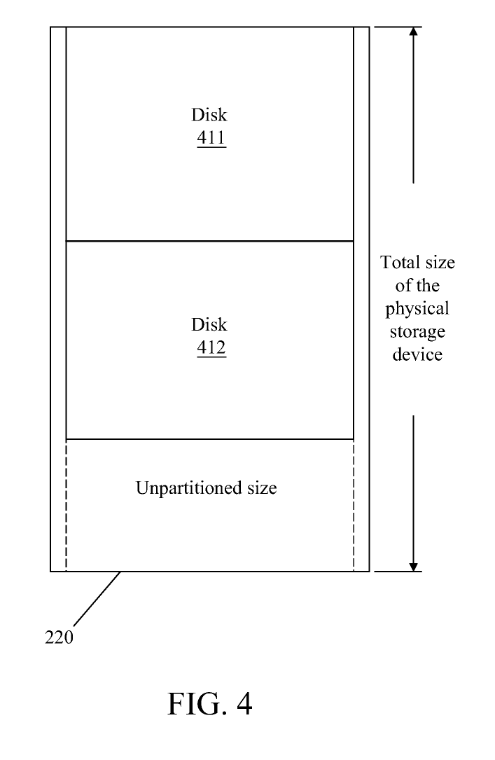

For example, when a physical storage device 220 having the size of 5 Terabytes is not partitioned into any disk, the unpartitioned size of the physical storage device 220 is 5 Terabytes. If the physical storage device 220 has two disks of 2 Terabytes, the unpartitioned size of the physical storage device 220 is 1 Terabytes (1=5−2*2). FIG. 4 is a schematic view of the disks and the unpartitioned size of the physical storage device. Referring to FIG. 4, one physical storage device 220 is shown, and two disks 411 and 412 of 2 Terabytes are portioned from the physical storage device 220, such that the unpartitioned size is 1 Terabytes.

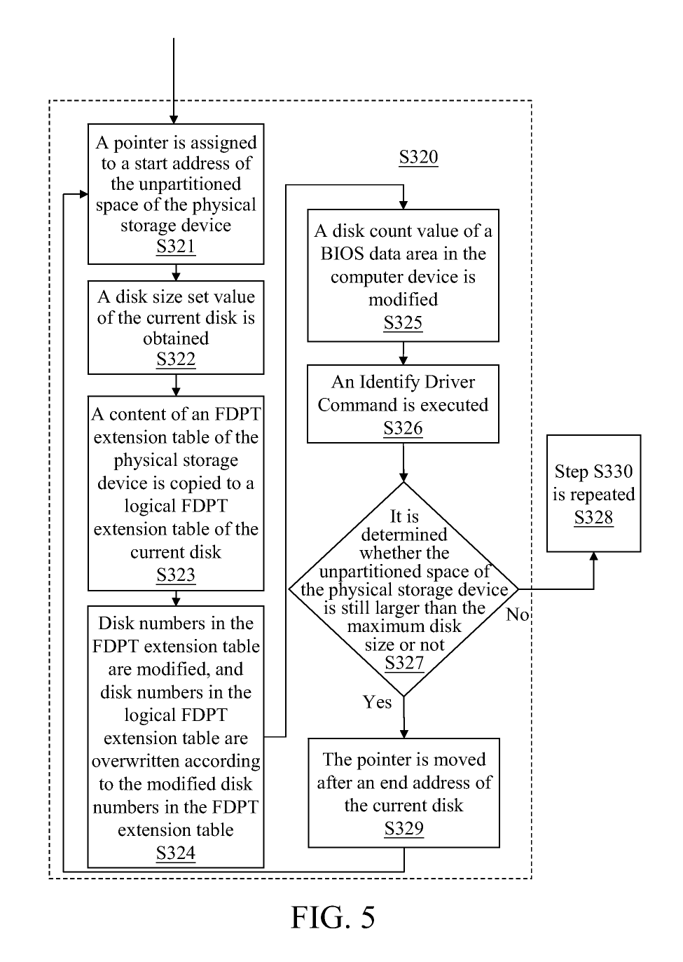

Next, it is determined whether the unpartitioned size of the physical storage device 220 is larger than the maximum disk size or not (corresponding Step S320). If the unpartitioned size of the physical storage device 220 is larger than the maximum disk size, the size planning procedure 214 is performed on the physical storage device 220. In the present invention, the disk on which the size planning procedure 214 is performed is defined to be a current disk. FIG. 5 is a schematic view of a detailed process of the size planning procedure according to the present invention. Referring to FIG. 5, the size planning procedure further comprises the following steps.

In Step S321, when the total size of the physical storage device is larger than the maximum disk size, a pointer is assigned to a start address of the unpartitioned space of the physical storage device.

In Step S322, a disk size set value of the current disk is obtained.

In Step S323, a content of an FDPT extension table of the physical storage device is copied to a logical FDPT extension table of the current disk.

In Step S324, disk numbers in the FDPT extension table are modified, and disk numbers in the logical FDPT extension table are overwritten according to the modified disk numbers in the FDPT extension table.

In Step S325, a disk driver count value of a BIOS data area in the computer device is modified.

In Step S326, an Identify Driver Command is executed, so as to plan one current disk having a size being the disk size set value in the physical storage device.

In Step S327, it is determined whether the unpartitioned space of the physical storage device is still larger than the maximum disk size or not.

In Step S328, when a residual size of the physical storage device is smaller than the maximum disk size, Step S330 is repeated.

In Step S329, when the residual size of the physical storage device is larger than the maximum disk size, the pointer is moved after an end address of the current disk, and Step S321 to Step S329 are repeated.

If no disk exists in the physical storage device 220, the pointer directly uses the start address of the physical storage device 220 as a reference (the movement of the pointer will be described in detail below). Similarly, when the partitioned disks exist in the physical storage device 220, the pointer uses the start address of the unpartitioned space as the reference.

Next, the processing unit 211 obtains the disk size set value to be partitioned of the current disk. In the present invention, the disk size set value may be input by a user, or may be a system default value. For example, if the user inputs the disk size set value, before the size planning procedure 214 is executed, a display interface having an input field is displayed on a screen, thereby receiving the disk size set value input by the user. If the fixed disk size set value is taken for example, when the size planning procedure 214 is executed, the processing unit 211 automatically sets the partition size of the current disk to the disk size set value. In other words, the disk size set value is set to 2 Terabytes.

Next, the processing unit 211 creates the logical FDPT extension table of the current disk. Then, the processing unit 211 copies the content of each field of the FDPT extension table of the physical storage device 220 to the logical FDPT extension table one by one, such that the content of the FDPT extension table is consistent with that of the logical FDPT extension table. The FDPT extension table is mainly used to record hardware parameters related to the physical storage device 220. The hardware parameters comprise an I/O port base address, a control port address, an interrupt request, a sector count, direct memory access (DMA) information, program I/O (PIO) information, a disk driver count, and a hardware specific option.

In Step S324, the field of the disk driver count is modified. It is assumed that each time when the size planning procedure 214 is executed, one disk is added, such that field values of the disk driver count are aggregated (that is, an accumulation number is “1” each time). Similarly, if the added disk driver count each time is n, the accumulation number is n each time. After the disk driver count in the FDPT is accumulated, the disk driver count of the logical FDPT extension table of the current disk is overwritten according to the new disk driver count.

After copying the logical FDPT extension table is completed, the processing unit 211 modifies the value of the disk driver count of the BIOS data area. The BIOS can only identify the detected physical storage device 220, but cannot identify the newly planned disks. Therefore, in order to enable the BIOS to identify the newly planned disks in the physical storage device 220, the count of the storage devices of the BIOS needs to be changed. In the present invention, after “1” is added to the disk driver count (generated in Step S324) of the FDPT extension table, the accumulation value is written into the value of the disk driver count of the BIOS data area. In other words, when the disk driver count of the FDPT extension table is “n”, the value of the disk driver count written into the BIOS data area is “n+1”.

Next, the processing unit 211 executes the Identify Driver Command. A current disk having the size of the disk size set value is planned in the physical storage device 220 according to the disk size set value of the current disk obtained in Step S322. The Identify Driver Command comprises a set sector count, a head count, a cylinder count, a hard disk sequence number, and other related parameters. Finally, the pointer is moved after the end address of the current disk, and serves as a start point of the next disk size planning process.

If the unpartitioned space of the physical storage device 220 is still larger than the maximum disk size, Step S321 to Step S328 are performed on the unpartitioned space of the physical storage device 220, so as to generate the new current disk, until the unpartitioned space of the physical storage device 220 is smaller than the maximum disk size.

In the corresponding Step S330, if the unpartitioned space of the physical storage device 220 is smaller than the maximum disk size, the conventional disk parameter setting procedure is performed on the physical storage device 220.

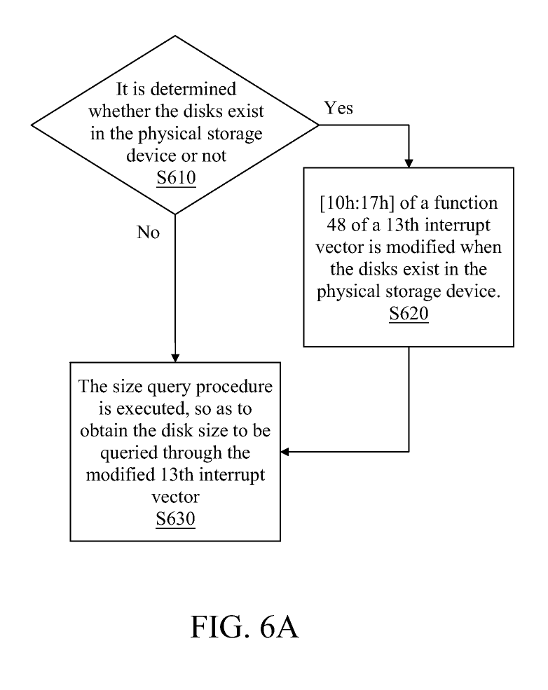

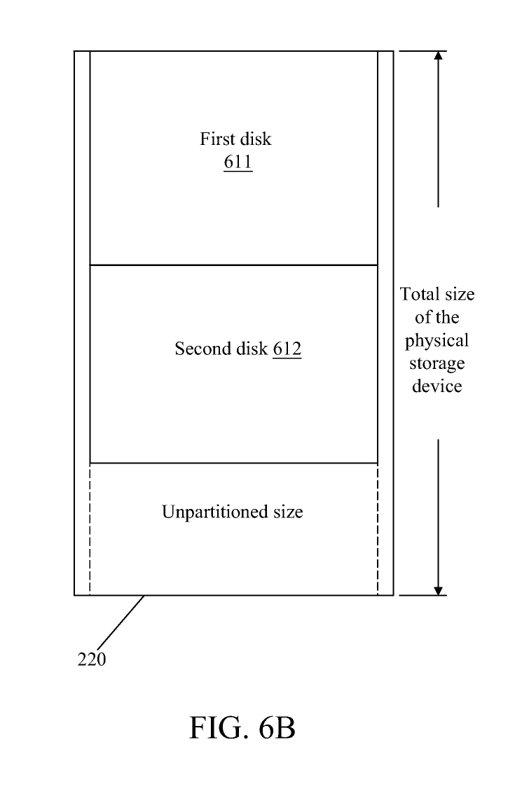

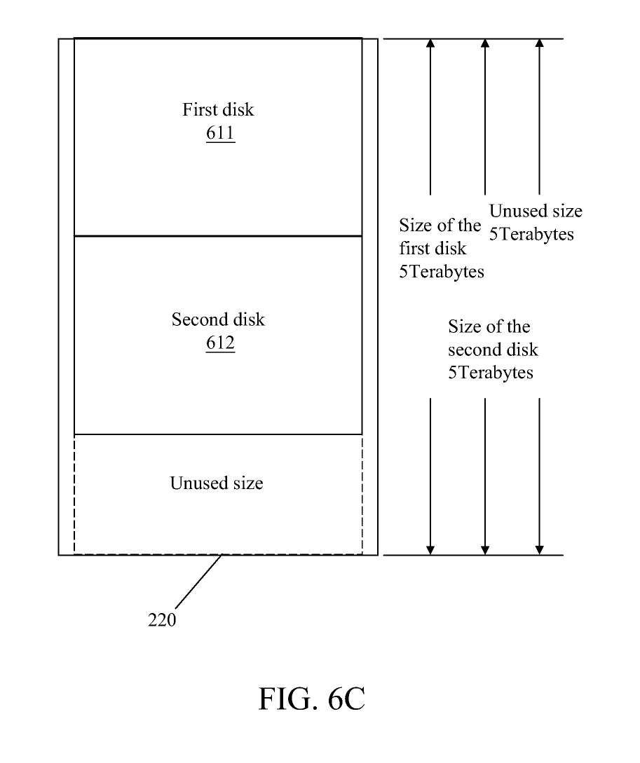

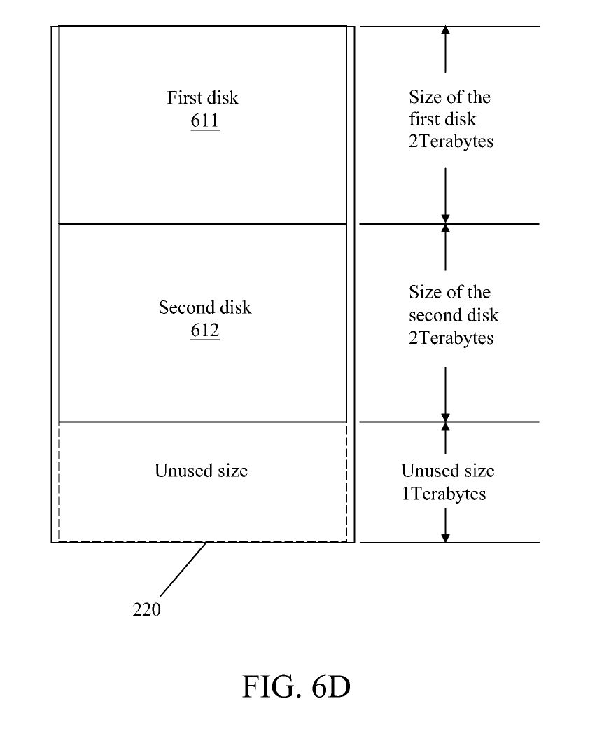

After the size planning procedure 214 is completed, for the access of the physical storage device 220, a procedure of correcting the start address of the disk needs to be performed. FIG. 6A is a schematic flow chart of a size query correcting procedure according to the present invention. Referring to FIG. 6A, the size query correcting procedure comprises the following steps.

In Step S610, it is determined whether the disks exist in the physical storage device or not.

In Step S620, [10h:17h] of a function 48 of a 13^{th} interrupt request is modified when the disks exist in the physical storage device.

In Step S630, the size query procedure is executed, so as to obtain the disk size to be queried through the modified 13^{th} interrupt request.

The original FDPT extension table in the physical storage device 220 is modified. Therefore, if it intends to query the size of the physical storage device 220, the size query procedure needs to be corrected. If the physical storage device 220 is queried when the size querying procedure is not corrected, the BIOS detects a plurality of disks having the same size as the physical storage device 220. Referring to FIG. 6B, the physical storage device 220 (comprising two disks of 2 Terabytes and one disk of 1 Terabytes) of 5 Terabytes is taken as an example. When the size query procedure is performed on the physical storage device 220 through the size querying procedure that is not corrected, according to the disk driver count stored in the FDPT extension table of the physical storage device 220, the BIOS considers that the start address of the first disk 611 and the start address of the second disk 612 in FIG. 6B is the start address of the physical storage device 220.

Thus, as shown in FIG. 6C, the BIOS mis-determines that the disks in the physical storage device 220 are the first disk 611 and the second disk 612 having the size of 5 Terabytes and an unused space of 5 Terabytes. Therefore, when the processing unit 211 detects that the processed disks 611 and 612 exist in the physical storage device 220 to be accessed, the processing unit 211 modifies [10h:17h] of the function 48 of the 13^{th} interrupt request (INT 13 for short). The function 48 of the INT 13 is used to read an offset calculation of the sector count. The offset is calculated according to the disk size set value. The function 48 of the INT 13 further has the description of the following access parameters. Referring to Table 1 and Table 2, physical definitions of the parameters and the offsets of the function 48 of the INT 13 are respectively shown.

TABLE 1
Parameters of the function 48 of the INT 13
Register

| | |
|---|---|
| AH | 48h = function number for extended_read_drive_parameters |
| DL | drive index (e.g. 1st HDD = 80h) |
| DS:SI | segment: offset pointer to Result Buffer, see below |

TABLE 2
Offsets in the function 48 of the INT 13
Result Buffer

| offset range | size | Description |
|---|---|---|
| 00h . . . 01h | 2 bytes | size of Result Buffer = 30 = 1Eh |
| 02h . . . 03h | 2 bytes | information flags |
| 04h . . . 07h | 4 bytes | physical number of cylinders = last index + 1 |
| | | (because index starts with 0) |
| 08h . . . 0Bh | 4 bytes | physical number of heads = last index + 1 |
| | | (because index starts with 0) |
| 0Ch . . . 0Fh | 4 bytes | physical number of sectors per track = last |
| | | index (because index starts with 1) |
| 10h . . . 17h | 8 bytes | absolute number of sectors = last index + 1 |
| | | (because index starts with 0) |
| 18h . . . 19h | 2 bytes | bytes per sector |
| 1Ah . . . 1Dh | 4 bytes | optional pointer to Enhanced Disk Drive (EDD) |
| | | configuration parameters |
| | | which may be used for subsequent interrupt |
| | | 13h |
| | | Extension calls (if supported) |

Referring to FIG. 6D, after the size query procedure is corrected, the processing unit 211 queries each disk according to the start address of each disk in the physical storage device 220. In this manner, the two disks 611 and 612 of 2 Terabytes and the unused space of 1 Terabytes exist can be correctly determined.

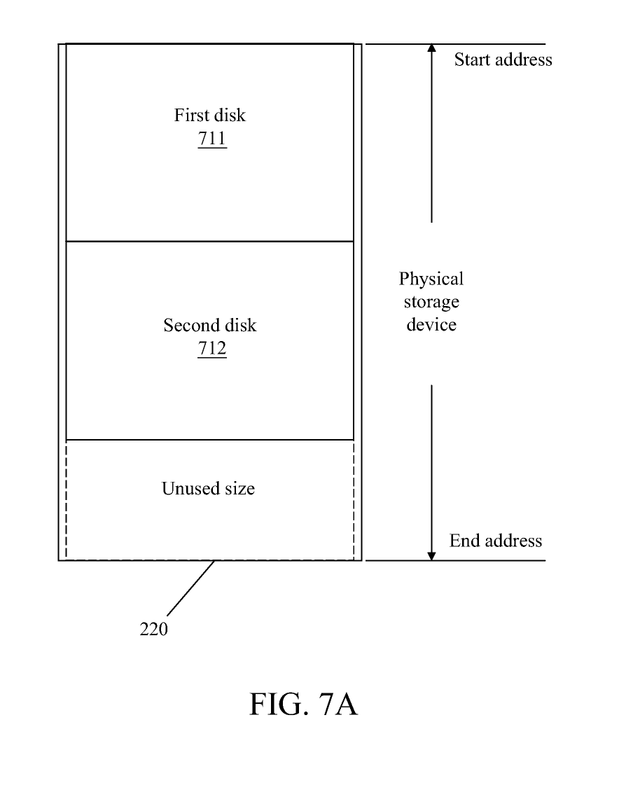

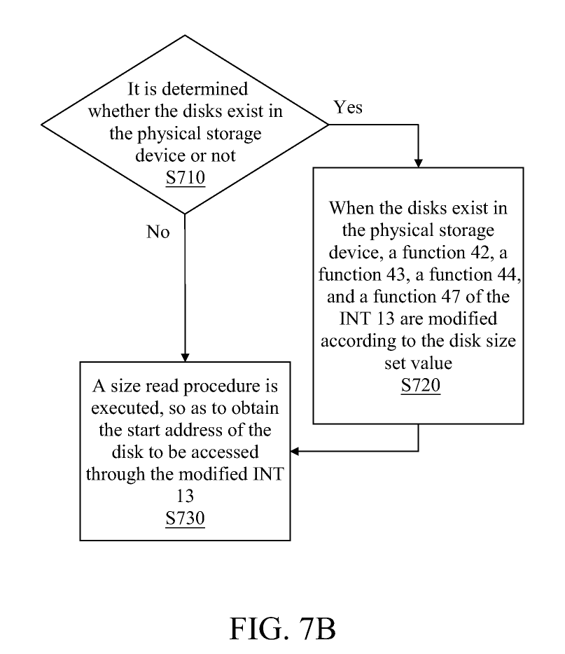

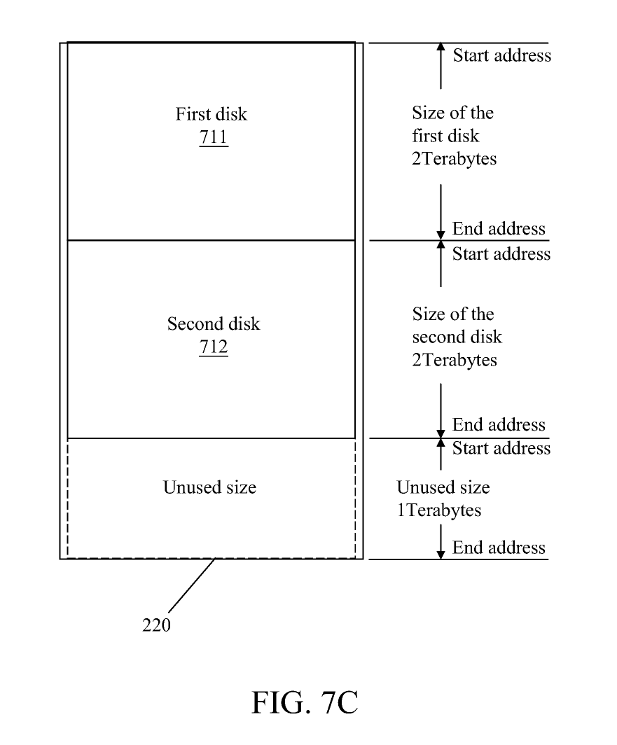

In addition to correcting the identification of the disk size, it is necessary to correct the access address. If the disk is accessed in a conventional accessing manner, the start address of the physical storage device 220 instead of the start address of each of the disks 711 and 712 is set as the reference (referring to FIG. 7A). Referring to FIG. 7B, the procedure of correcting the start address of the disk comprises the following steps.

In Step S710, it is determined whether the disks exist in the physical storage device or not.

In Step S720, when the disks exist in the physical storage device, a function 42, a function 43, a function 44, and a function 47 of the INT 13 are modified according to the disk size set value.

In Step S730, a size read procedure is executed, so as to obtain the start address of the disk to be accessed through the modified INT 13.

TABLE 3
Parameters of the function 42 of the INT 13
Register

| | |
|---|---|
| AH | 42h = function number for extended read |
| DL | drive index (e.g. 1st HDD = 80h) |
| DS:SI | segment: offset pointer to the DAP, see below |

TABLE 4
Offsets in the function 42 of the INT 13
DAP: Disk Address Packet

| offset range | size | Description |
|---|---|---|
| 00h | 1 byte | size of DAP = 16 = 10h |
| 01h | 1 byte | unused, should be zero |
| 02h | 1 byte | number of sectors to be read, 0 . . . 127 (=7Fh) |
| 03h | 1 byte | unused, should be zero |
| 04h . . . 07h | 4 bytes | segment: offset pointer to the memory buffer to |
| | | which sectors will be transferred |
| 08h . . . 0Fh | 8 bytes | absolute number of the start of the sectors to be |
| | | read (1st sector of drive has number 0) |

After the access address is corrected, the processing unit 211 performs the data access according to the correct start address of each of the disks 711 and 712, as shown in FIG. 7C.

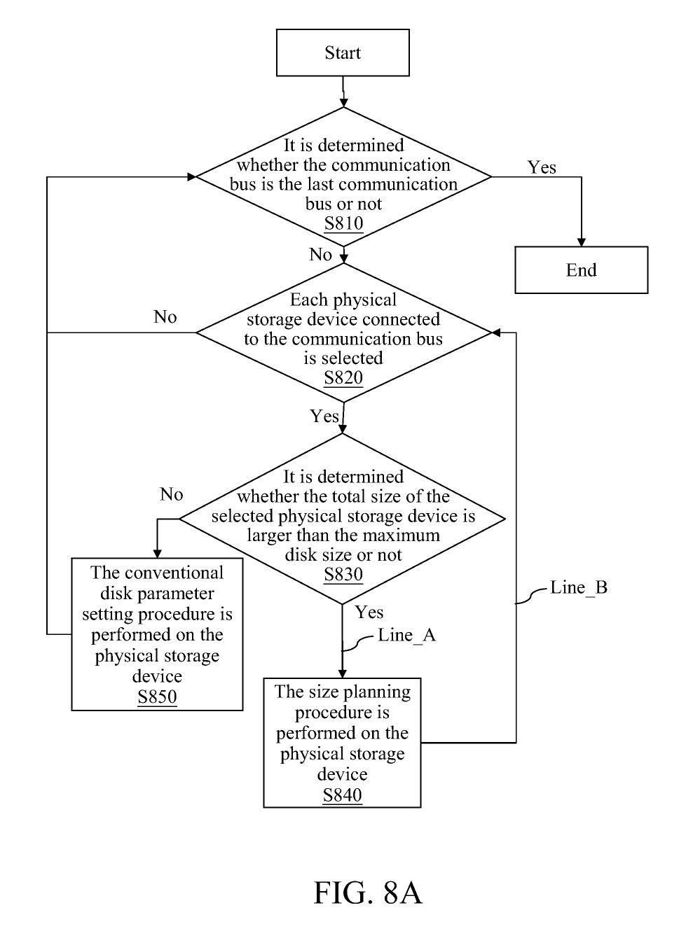

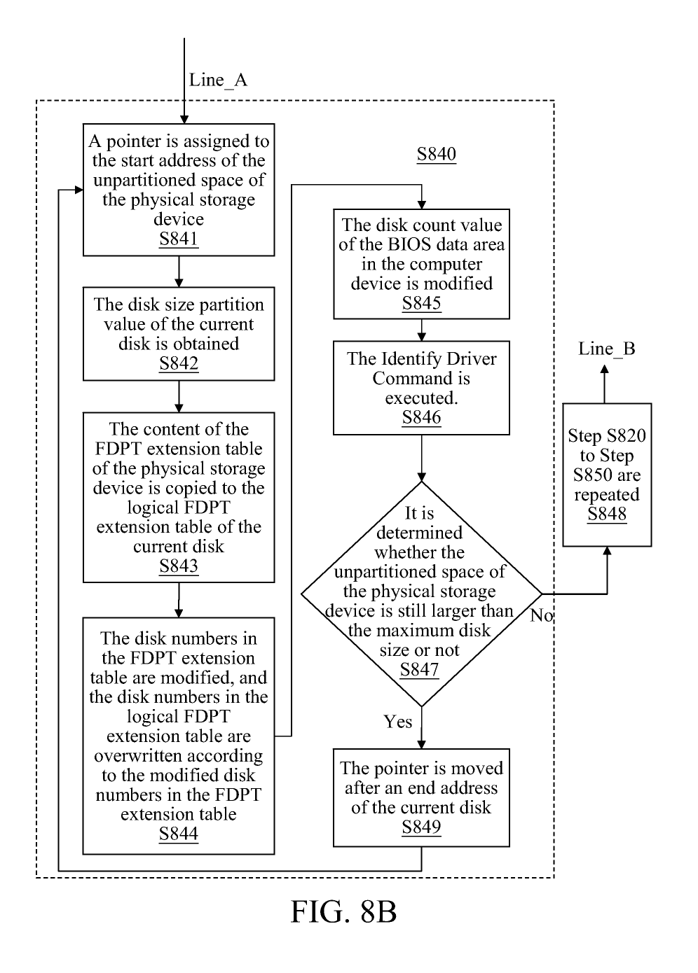

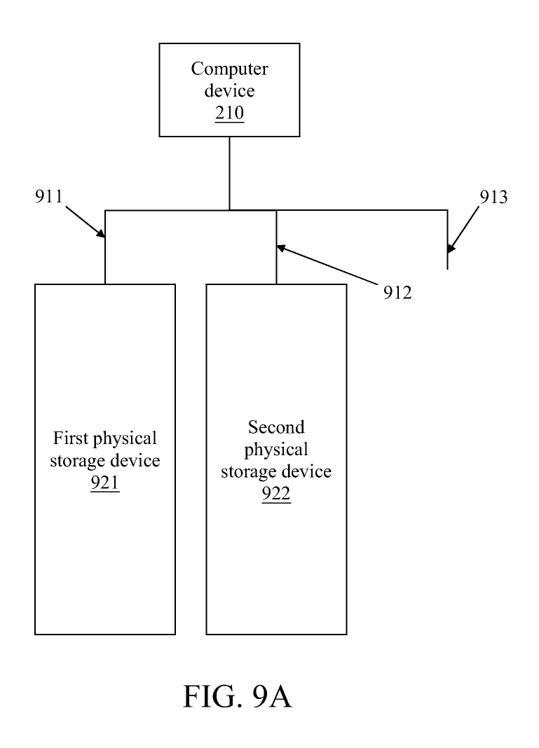

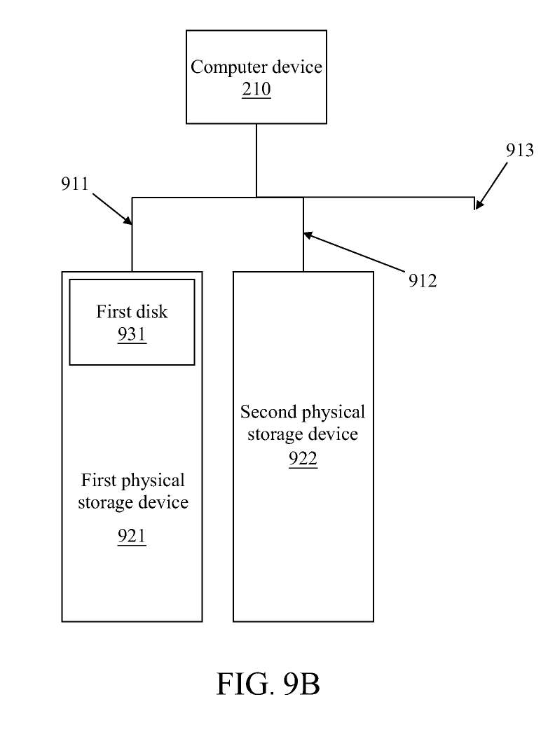

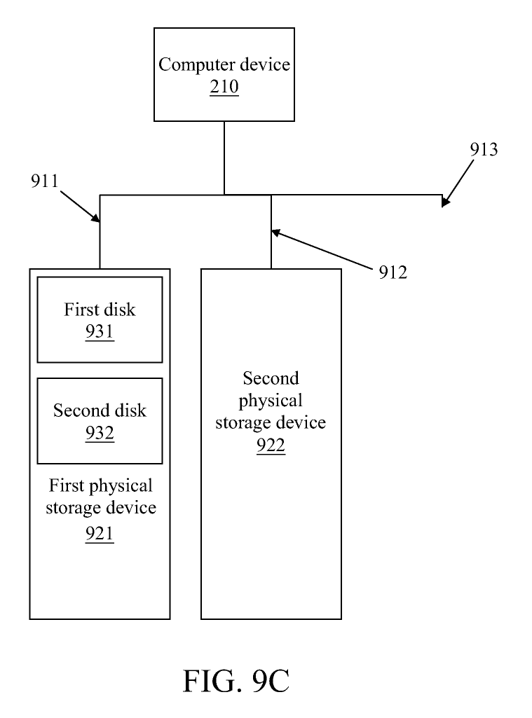

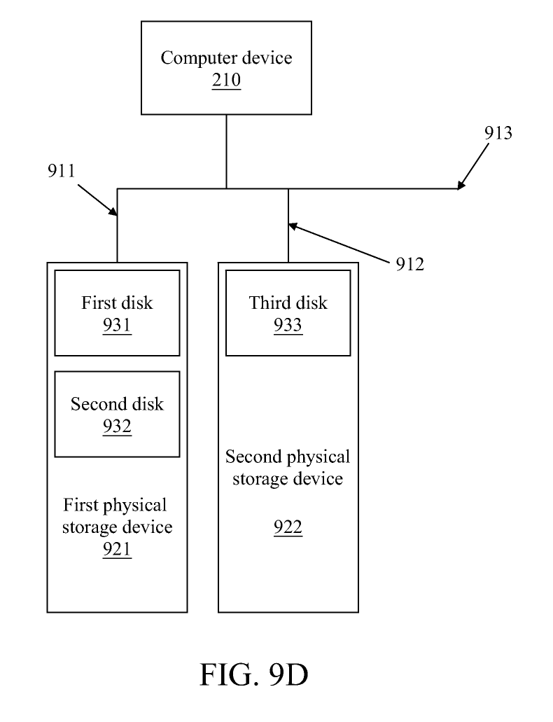

Referring to FIGS. 8A, 8B, 9A, 9B, 9C, and 9D, the two physical storage devices 220 defined as a first physical storage device 921 (having the size of 5 Terabytes) and a second physical storage device 922 (having the size of 3 Terabytes) are taken for example to describe the disk size planning process. The computer device 210 has a first communication bus 911, a second communication bus 912, and a third communication bus 913. The first communication bus 911 is connected to the first physical storage device 921, the second communication bus 912 is connected to the second physical storage device 922, and the third communication bus 913 is not connected to any physical storage device 220. The maximum disk size is 2 Terabytes, and the disk size set value is fixed to be 2 Terabytes.

In order to clearly describe the operation process of the plurality of physical storage devices 220, the following process is used for description. Referring to FIG. 8A, the operation process on the plurality of physical storage devices 220 comprises the following steps.

In Step S810, it is determined whether the communication bus is the last communication bus or not.

In Step S820, if the communication bus is not the last communication bus, each physical storage device connected to the communication bus is selected.

In Step S830, it is determined whether the total size of the selected physical storage device is larger than the maximum disk size or not.

In Step S840, when the total size of the selected physical storage device is larger than the maximum disk size, the size planning procedure is performed on the physical storage device.

In Step S850, when the total size of the selected physical storage device is smaller than the maximum disk size, the conventional disk parameter setting procedure is performed on the physical storage device.

Firstly, during the POST, the computer device 210 detects that the first communication bus 911 is connected to the first physical storage device 921. Firstly, as the total size of the first physical storage device 921 exceeds the maximum disk size, the processing unit 211 performs the size planning procedure 214 on the first physical storage device 921. For the plurality of physical storage devices, referring to FIG. 8B, the process comprises the following steps.

In Step S841, when the total size of the physical storage device is larger than the maximum disk size, a pointer is assigned to the start address of the unpartitioned space of the physical storage device.

In Step S842, a disk size partition value of the current disk is obtained.

In Step S843, the content of the FDPT extension table of the physical storage device is copied to the logical FDPT extension table of the current disk.

In Step S844, the disk numbers in the FDPT extension table are modified, and the disk numbers in the logical FDPT extension table are overwritten according to the modified disk numbers in the FDPT extension table.

In Step S845, the disk driver count value of the BIOS data area in the computer device is modified.

In Step S846, the Identify Driver Command is executed, so as to plan a current disk having the size of the disk size partition value in the physical storage device.

In Step S847, it is determined whether the unpartitioned space of the physical storage device is still larger than the maximum disk size or not.

In Step S848, when the residual size of the physical storage device is smaller than the maximum disk size, Step S820 to Step S850 are repeated.

In Step S849, when the residual size of the physical storage device is larger than the maximum disk size, the pointer is moved after an end address of the current disk, and Step S841 to Step S849 are repeated.

FIG. 9A is a schematic view of the size planning operation on each physical storage device. During the first size planning procedure 214, the first physical storage device 921 assigns the pointer to the start address of the unpartitioned space of the physical storage device, and starts the disk size planning process. In order to clearly describe the difference between disks, the disk is defined to be a first disk 931.

Then, the content of the FDPT extension table of the first physical storage device 921 is copied to the logical FDPT extension table of the first disk 931, and the disk numbers in the FDPT extension table are modified. Here, the disk numbers in the logical FDPT extension table are overwritten according to the modified disk numbers in the FDPT extension table. Next, the disk driver count value of the BIOS data area is modified. The Identify Driver Command is executed, so as to plan the first disk 931 having the size of the disk size set value in the first physical storage device 921. After the steps, the process of setting the first disk 931 is completed. Referring to FIG. 9B, it is a schematic view of the first disk.

In the first physical storage device 921, a size of 3 Terabytes is not planned. Therefore, the processing unit 211 continues to perform the size planning procedure 214 on the first physical storage device 921, so as to generate a second disk 932 having a size of 2 Terabytes. FIG. 9C is a schematic view of the second disk. Referring to FIG. 9C, in the first physical storage device 921, the residual space is only 1 Terabytes. Therefore, the processing unit 211 stops processing the first physical storage device 921. The computer device 210 may identify the residual space of 1 Terabytes of the first physical storage device. Therefore, the procedure needs not to be performed on the residual space of 1 Terabytes.

Next, the processing unit 211 detects the second physical storage device 922 connected to the second communication bus 912. Similarly, the unused size of the second physical storage device 922 is larger than the maximum disk size. Therefore, the processing unit 211 performs the size planning procedure 214 on the second physical storage device 922, and generates a corresponding third disk 933. The unused space of the second physical storage device 922 is smaller than the maximum disk size, such that the size planning procedure 214 performed on the second physical storage device 922 is ended. Referring to FIG. 9D, it is a schematic view of the third disk. Finally, the processing unit 211 detects whether the third communication bus 913 is connected to a physical storage device or not. The third communication bus 913 is not connected to any physical storage device 220, so the processing unit 211 ends the size planning procedure.

What is claimed is:

1. A size planning method for a storage device, for performing a disk size planning process on a physical storage device when a computer device is booted, the size planning method comprising:
a. determining whether a total size of the physical storage device is larger than a maximum disk size or not;
b. pointing to a start address of an unused space of the physical storage device by a pointer when the total size of the physical storage device is larger than the maximum disk size;
c. obtaining a disk size set value of a current disk;
d. copying a content of a fixed disk parameter table (FDPT) extension table of the physical storage device to a logical FDPT extension table of the current disk;
e. modifying disk numbers in the FDPT extension table, and overwriting disk numbers in the logical FDPT extension table according to the modified disk numbers in the FDPT extension table;
f. modifying a disk driver count value of a basic input/output system (BIOS) data area in the computer device;
g. executing an Identify Driver Command, so as to determine the disk size set value of the current disk; and
h. repeating Step a to Step h after moving the pointer to an end address of the current disk when an unpartitioned space of the physical storage device is larger than the maximum disk size.

2. The size planning method for a storage device according to claim 1, wherein before Step a, the method further comprises:
detecting whether a communication bus is a last communication bus or not;
detecting whether each communication bus is connected to the physical storage device or not if the communication bus is not the last communication bus; and
executing Step a to Step h until all the physical storage devices connected to the communication buses are completed when the physical storage device is connected to the selected communication bus.

3. The size planning method for a storage device according to claim 1, wherein the maximum disk size is 2 Terabytes.

4. The size planning method for a storage device according to claim 1, wherein the FDPT extension table comprises a disk size, a cylinder count, a head count, and a sector count.

5. The size planning method for a storage device according to claim 1, wherein Step e of modifying the disk numbers in the FDPT extension table further comprises:
accumulating the disk numbers in the FDPT extension table, and modifying the disk numbers in the FDPT extension table according to an accumulation result.

6. A read correcting method for the storage device according to claim 1, for correcting a manner of reading a size of the physical storage device after the size planning is completed, the read correcting method comprising:
determining whether the disks exist in the physical storage device or not; and
modifying [10h:17h] of a function 48 of a 13^{th} interrupt request according to the disk size set value when the disks exist in the physical storage device.

7. An access correcting method for the storage device according to claim 1, for correcting a manner of accessing the physical storage device after the size planning is completed, and obtaining data of a correct address from the storage device, the access correcting method comprising:
determining whether the disks exist in the physical storage device or not; and
modifying a function 42, a function 43, a function 44, and a function 47 of a 13^{th} interrupt request according the disk size set value when the disks exist in the physical storage device.
